(19) United States
(12) Patent Application Publication
(10) Pub. No.: US 2023/0314075 A1
(43) Pub. Date: Oct. 5, 2023

(54) WOOD DRYING PROCESS, DRIED WOOD OBTAINED AND DRIED WOOD ELEMENT FOR COVERING CONTAINERS

(71) Applicant: QUADPACK INDUSTRIES S.A., L'HOSPITALET DE LLOBREGAT (ES)

(72) Inventors: Joan COLOMER CASAS, L'HOSPITALET DE LLOBREGAT (ES); Eduard MACHADO EGUZQUIZA, L'HOSPITALET DE LLOBREGAT (ES); David MERINO DE DIEGO, L'HOSPITALET DE LLOBREGAT (ES)

(73) Assignee: QUADPACK INDUSTRIES S.A., L'HOSPITALET DE LLOBREGAT (ES)

(21) Appl. No.: 18/044,633

(22) PCT Filed: Oct. 13, 2020
(86) PCT No.: PCT/ES2020/070618

§ 371 Date: Mar. 9, 2023

(30) Foreign Application Priority Data
Sep. 16, 2020 (ES) U202032019

(51) Int. Cl. F26B 21/10; F26B 21/08; F26B 9/06

(52) U.S. Cl. CPC F26B 21/10; F26B 21/08; F26B 9/06; F26B 2210/16

(57) ABSTRACT

Procedure for drying wood, dried wood obtained therefrom and covering element for containers made of the dried wood obtained.

Of the type applied after the wood has been cut at its source, the wood having lost humidity and the wood having an equilibrium moisture content of about 41% or more.

### DESCRIPTION

Procedure for drying wood, dried wood obtained therefrom and covering element for containers made of the dried wood obtained, of the type applied after the wood has been cut at its origin, the wood has lost moisture, and the wood having an equilibrium moisture content of 41% or more, characterised in that it comprises: a first stage in which the wood is introduced in the oven at a temperature between 40-50° C. and a relative humidity between 40-50%, for a period between 1 and 3 weeks, until the wood reaches an equilibrium moisture content between 25%-40%; a second stage in which the dried wood from the previous stage is introduced in the oven at a temperature between 45-55° C. and a relative humidity between 45-55%, for a period between 4 and 15 days, until the wood reaches an equilibrium moisture content between 16%-25%; a third stage in which the dried wood from the second stage is introduced in the oven at a temperature between 50-60° C. and a relative humidity between 30-40%, for a period between 4 and 15 days, until the wood reaches an equilibrium moisture content between 10%-16%; a fourth stage in which the wood obtained from the third stage is set aside at a controlled temperature between 18-25° C., between 2 and 4 weeks, wherein the wood recovers part of the equilibrium moisture lost in the third stage and stabilizes, a fifth stage in which the wood from the fourth stage is introduced in the oven at a temperature between 50-60° C. and a relative humidity between 25-35%, for a period between 4 and 15 days until the wood reaches an equilibrium moisture content between 10%-16%, a sixth stage in which the wood from the fifth stage is introduced in the oven at temperature between 40-50° C. and a relative humidity between 20-30%, for a period between 4 and 15 days until the wood reaches an equilibrium moisture content between 6%-8%, and, a seventh stage in which the wood obtained from the sixth stage is allowed to rest at a controlled temperature between 18-25° C., for a period between 3 and 5 weeks, whereat the wood recovers between 1.5 and 2.5% equilibrium humidity, the remains of temperature dissipate and the wood stabilizes, having a final humidity equilibrium between 8%-10%.

### BACKGROUND OF THE INVENTION

In the state of the art, different procedures are known of drying wood that aim at obtaining elasticity thereof.

Thus, state of the art is Chinese Patent CN102252502 “METHOD AND DEVICE FOR DRYING WOOD”, of the year 2011, in the name XIZE YU, which refers to a method for drying wood. The method is characterised by comprising the sequential stages of: processing the wood by segments of wood of the required size, placing the wood segments in the drying devices and sealing the drying device; starting up a heating device, heating the drying device and securing that it reaches 65-80° C. and is maintained at such temperature for a period between 20 minutes to 2 hours; starting up a suction device, vacuum the drying device to ensure that the intensity of the absolute pressure is kept within the range of not less than −0.098 MPa and no more than −0.05 MPa and is maintained as such between 20 minutes to 2 hours; start up a flushing device for pumping water; and turning off the heating device, the suction device, and the water flushing device, and taking the wood segments out. According to a method, the resin membranes inside the wood are damaged to achieve a speedy drying, the water and air permeability of the wood is improved, and the flexibility is increased. The method provided by the invention has the advantages of simplicity, short drying time, high efficiency, energy saving, cost reduction, low rate of degradation of the wood and similar advantages. In addition, the invention describes a drying device.

State of the art is also Chines patent CN109682172 “Method for drying wood through moist heat microwave”, in the name KOU ZONGHUI, of the year 2019, referring to a method for drying wood through moist heat microwave. The method comprises the stages of (1) loading the wood, (2) injecting water, (3) executing the microwave heating and (5) extracting the moisture and cooling. In the process of drying the wood with steam, the flexibility of the wood fibre is maintained, while maintaining a good protective effect on the wood and avoiding wood distortion. The steam carries a large amount of the humidity, the wood is dried with moist heat, the humidity of the steam is absorbed when the wood absorbs the heat and, under the condition that the surface of the wood be moist, the surface is not dry, which prevents the cracking of the surface. Under heating and humidity conditions, the resin of the wood is softened so as to reach the effect that the waterways of the wood are unblocked and the wood moist can freely enter or exit, thus avoiding the internal cracking of the wood. The wood fibre cannot abruptly shrink under the effect of the moist heat, nor does it weaken, the fibre extensibility and flexibility being high.

### BRIEF DESCRIPTION OF THE INVENTION

The present invention the type of patents that describe procedures for drying wood in ovens.

The closest document is Chinese patent No. CN102252502.

That patent solves the problem of wood flexibility by means of a procedure that dries the wood applying temperatures above 60° C. and pressure in periods of between 20 minutes and 2 hours.

That patent, on the other hand, has the disadvantage that the wood is damaged and bending occurs. To make up for this, pressure Is applied. In addition, the wood cracks due to the aggressive procedure and the flexibility obtained at the end of the procedure is not relevant.

The present procedure solves the above problem by applying controlled temperature and a relative humidity inside the oven, using low temperatures at the beginning and lowering the balance moisture very gradually, and performing the procedure throughout very long periods, thus avoiding the occurrence tensions, cracks and changes of colour in the wood. Moreover, no undesired movement of the wood fibres occur.

In addition, the wood obtained with this procedure will have a smooth contraction due to the progressive application of temperature and the controlled loss of moisture. In this manner, bending of the wood as a result of the drying is prevented and the wood remains plane and stable.

In addition, the procedure that is the object of the invention can be applied to a large variety of woods, as different as beech, pine, ash, maple, etc.

An object of the present invention is a procedure for drying wood, of the type applied after the wood has been cut at its origin, the wood has lost moisture and has reached an equilibrium moisture content of 41% or more, characterised in that it comprises: a first stage in which the wood is introduced in the oven at a temperature between 40-50° C. and a relative humidity between 40-50%, for a period between 1 and 3 weeks, until the wood reaches an equilibrium moisture content between 25%-40%, a second stage in which the dried wood from the previous stage is introduced in the oven at a temperature between 45-55° C. and a relative humidity between 45-55%, for a period between 4 and 15 days, until the wood reaches an equilibrium moisture content between 16%-25%, a third stage in which the dried wood from the second stage is introduced in the oven at a temperature between 50-60° C. and a relative humidity between 30-40%, for a period between 4 and 15 days, until the wood reaches an equilibrium moisture content between 10%-16%, a fourth stage in which the wood obtained from the third stage is set aside at a controlled temperature between 18-25° C., between 2 and 4 weeks, wherein the wood recovers part of the equilibrium moisture lost in the third stage and stabilizes, a fifth stage in which the wood from the fourth stage is introduced in the oven at temperature between 50-60° C. and a relative humidity between 25-35%, for a period between 4 and 15 days until the wood reaches an equilibrium moisture content between 10%-16%, a sixth stage in which the wood from the fifth stage is introduced in the oven at a temperature between 40-50° C. and a relative humidity between 20-30%, for a period between 4 and 15 days until the wood reaches an equilibrium moisture content between 6%-8%, and a seventh stage in which the wood obtained from the sixth stage is allowed to rest at a controlled temperature between 18-25° C., for a period between 3 and 5 weeks, whereat the wood recovers between 1.5 and 2.5% equilibrium humidity, the remains of temperature dissipate and the wood stabilizes having a final humidity equilibrium between 8%-10%.

A second additional object of the present invention is dried wood obtained in accordance with the procedure of claim 1, characterised in that it comprises an equilibrium moisture content between 8-10%.

A third additional object of the present invention is a covering element for containers of the dried wood obtained according to claim 4, of the type attached to the orifice or the neck of the container, characterised in that it comprises a body that defines a cavity having walls inside which the orifice and the neck of the container are arranged, and attachment means of the walls to the orifice or to the neck of the container, said attachment means consisting at least of a strap.

### BRIEF DESCRIPTION OF THE DRAWINGS

To facilitate the explanation, this description includes four sheets of drawings representing a practical embodiment, which is provided by way of a non-limiting example of the scope of the present invention:

FIG. 1 is a general view of a covering element,

FIG. 2 is a lower view of FIG. 1,

FIG. 3 is a side view of FIG. 1,

FIG. 4 is a sectional cut by the line IV-IV of FIG. 3,

FIG. 5 is a sectional cut of the covering element already assembled to the container.

### PRACTICAL EMBODIMENT OF THE PRESENT INVENTION

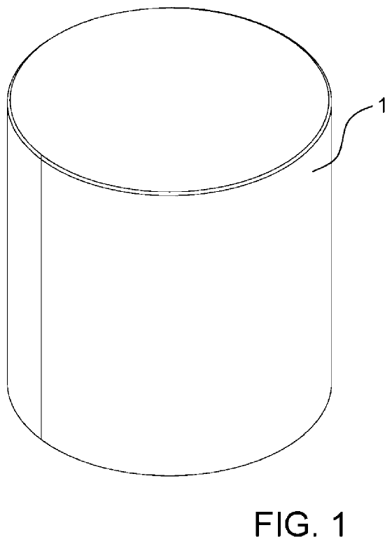

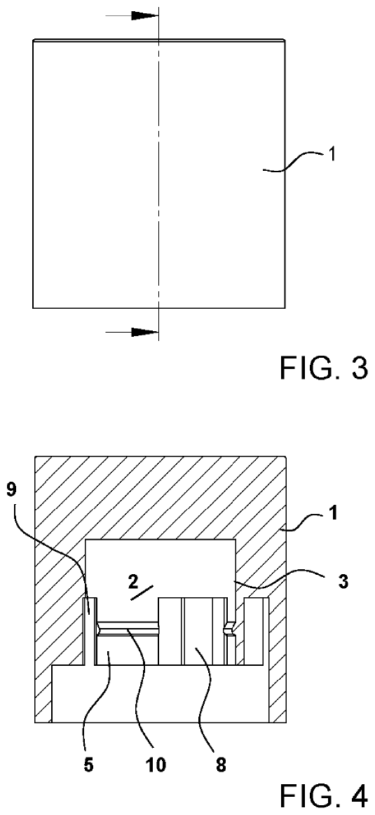

FIGS. 1 and 3 illustrate a body 1.

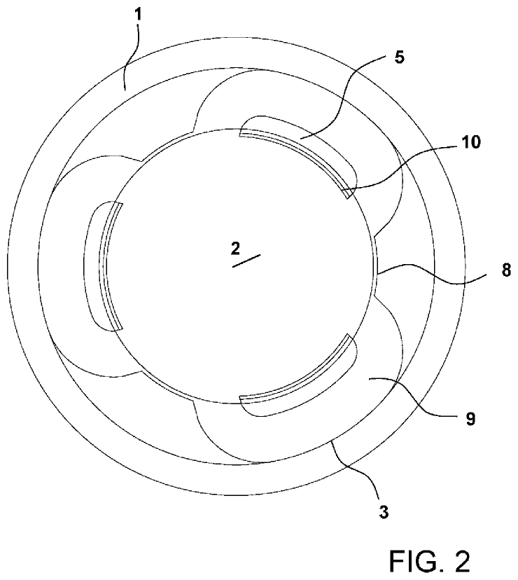

FIGS. 2 and 4 illustrate a body 1, a cavity, walls 3, a strap 5 having a bulge 10, elements for positioning the neck 8 and a recess 9.

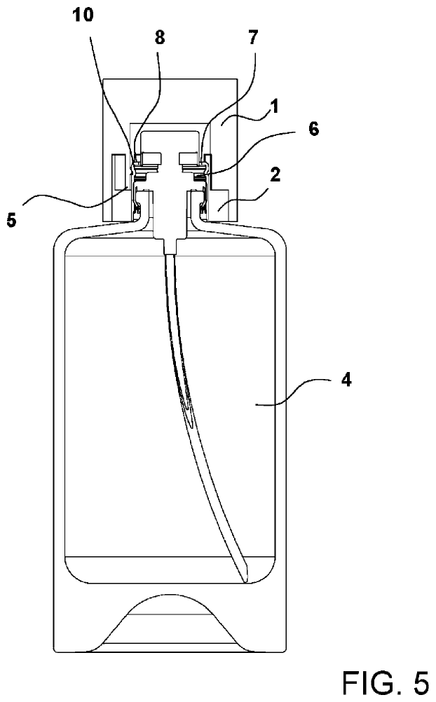

Last, FIG. 5 shows a covering element 11 or cap, the body 1, the cavity, the strap 5 with its bulge 10, the elements for positioning the neck 8 and a container 4 with its neck 6, its protrusion 12 and its opening 7.

Preliminarily, the equilibrium moisture content is defined as the state wherein the humidity of the wood reaches an equilibrium with the environmental conditions to which it is subjected.

In addition, it should be noted that no two trees are alike, even if one grows next to the other. Nor are there two equal pieces of wood, even if they come from the same trunk (a piece of wood from the part of the trunk close to the ground will not be the same as another piece from the top of the trunk).

The ranges of temperatures, humidity, etc., indicated are useful for manoeuvring within the specific characteristics of each piece of wood, bearing in mind the starting assumption that two trees of the same species and the same forest will always different.

For example, if the grains of the wood are narrow, it means that the wood is harder there than in the area where the wood grains are wider, which will be more flexible and more elastic. In effect, this characteristic coincides with the rainfall periods that the tree as undergone. Especially in countries with dry and rainy seasons, the same trunk will have areas where the grains are very near (which will coincide with a period of drought) and others where the grains will be further apart, corresponding to periods of rain.

By way of example, the beech wood obtained from a forest in Montseny, near Barcelona, where the rainy periods occur in certain seasons of the year, will show alternate separate and near grains, as compared to beech wood from an East-Europe forest (for instance, the Carpathian mountains) where the rains fall throughout the year, the grains will be arranged with regular spacing. This means that the second wood will always be more flexible than the first one and will have more moisture at balance at the time of felling, even though both are the species of wood, namely beech wood.

In addition, the type of cut can influence the drying. The relative inclination of the cut can limit the flexibility.

The density of the wood is also a conditioning element.

If, in addition, there are different species of wood, the variations between them will justify the variation in percentages and in the ranges of temperature to be applied, as there shall also be different densities.

The procedure for drying wood of the present invention is of the type applied after the wood has been cut at the source and the wood has lost moisture. In other words, after the wood is cut, it starts losing humidity.

The wood used in the present procedure should have an equilibrium moisture content of about 41% or higher, approximately 60%. In case the wood would have a higher % than 60%, a there would be prior drying stage until reaching said range between 41-50%.

In this way, the procedure is started by a first stage wherein the wood is introduced in the oven at a temperature between 40-50° C. and a relative humidity between 40-50%, for a period between 1 and 3 weeks until the wood reaches an equilibrium moisture content between 25%-40%.

These ranges are determined in view that certain types of woods will need a higher or a lower temperature, or for longer or shorter periods within the range, or a relative higher or lower humidity, all of which depends on the characteristics and the density of each particular wood.

In a second stage the dried wood from the previous stage is introduced in the oven at a temperature between 45-55° C. and a relative humidity between 45-55%, for a period between 4 and 15 days until the wood reaches an equilibrium moisture content between 16%-25%.

In the third stage, the dried wood from the second stage is introduced in the oven at a temperature between 50-60° C. and a relative humidity between 30-40%, for a period between 4 and 15 days, until the wood reaches an equilibrium moisture content between 10%-16%.

In the fourth stage, the wood obtained from the third stage is allowed to rest at a controlled temperature between 18-25° C., during 2 and 4 weeks. The wood now recovers part of the humidity lost in the third stage and stabilizes. Recovery by the wood of such lost humidity equilibrium depends on the type of wood and ranges between 1% to 9%.

The procedure continues to a fifth stage in which the wood from the fourth stage is introduced to the oven at a temperature between 50-60° C. and a relative humidity between 25-35%, for a period between 4 and 15 days, until the wood reaches an equilibrium moisture content between 10%-16%.

In the sixth stage the wood dried from the previous stage is introduced in the oven at a temperature between 40-50° C. and a relative humidity between 20-30%, for a period between 4 and 15 days, until the wood reaches an equilibrium moisture content between 6%-8%.

Last, in the seventh stage, the wood obtained from the sixth stage is allowed to rest at a controlled temperature between 18-25° C., for a period of 3 to 5 weeks, whereat the wood recovers between 1.5 to 2.5% equilibrium humidity, the remains of temperature dissipate and the wood stabilizes, having a final humidity equilibrium between 8%-10%.

Optionally, in at least one of the stages first, second, third, fifth and sixth, when the equilibrium humidity level is lower than the pre-established parameters, a water shower is applied until the equilibrium humidity recovers the pre-established parameters. That is, since there are no two identical woods, if there is an equilibrium humidity issue with one of them because it dries too quickly, water is poured over it to solve this problem.

The wood obtained according to the above-described procedure is a dried wood having an equilibrium moisture content in the range of 8-10%. One of the advantages of the wood dried according to the above-described procedure is that its flexibility increases 1.5 to 2 times comparatively to the flexibility it would have if it had been dried by an air-drying procedure. That is, a dried wood having little or null flexibility is transformed into a flexible wood, which allows applying the covering element 11 that will be described hereunder.

One of the options for the use of such dried wood is by way of a covering element 11 for dried wood containers, as explained above.

EI covering element 11 is of the type that is attached to the opening 7 or to the neck 6 of container 4, such as a top or a cap.

The covering element 11 comprises a body 1 which defines a cavity 2 having walls 3, inside which are the opening 7 and neck 6 of the container (FIG. 5), and attachment means 5 for fixing the walls 3 to the opening or the neck, such attachment means 5 consisting at least one strap. The straps 5 may be as many as needed, starting from one.

To facilitate the flexing of the strap 5, the walls 3 comprise a recess 9 provided behind the strap 5. In this way it, a narrower covering element 11 can be made, as the spacing for the flexing of the strap 5 is obtained from the recess.

In order to allow the attachment of the covering element to the container 4, the strap 5, which is at least one, may optionally comprise at least one bulge 10 that fits into a protrusion 12 of the neck 6 of the container.

To facilitate guiding and engagement of the covering element with the container 4, the walls 3 comprise positioning elements 8 for the neck 6, which guide it towards a perfect positioning. In addition, it is useful to secure the attachment of the covering element 11 to the container 4 once the strap 5 has been blocked at the neck 6.

This covering element 11 is very suitable, since it may apply a force for closing a container 4, for example, as the wood may reach the end of the path and adapt to the final fitting with the container, either starting up from a thread or from a clicking system.

Now, in a practical embodiment, the workers will introduce the wood in the oven. For this practical embodiment, ash wood has been selected, arranged in strips of 40×40×600 cm, duly palletized and with adequate circulation of air. Besides this rectangular shape indicated, other shapes may be also suitable, such as a square or a round shape.

The woods may have a thickness between 20 cm (thin wood) to 100 cm (thick wood). Larger thicknesses could also be dried but the drying, due to the greater thickness, will be much more complicated.

The wood volume will be approximately 20 m³. Therefore, the oven should have a capacity enough to contain the 20 m³.

The wood starts to lose equilibrium moisture content as from the felling. In certain cases, throughout the period comprised between the felling of the trees, the preparation at the sawmill and its arrival to the oven, the wood will already have an equilibrium moisture content of about 41-50%, and will therefore be ready for the first stage.

In case the wood has not yet released the humidity and reached such 41-50%, it will have to be introduced into the oven for a pre-drying step, where the wood is heated for a period of one to three days, depending on the % of equilibrium moisture content, until it reaches an equilibrium moisture content in the range of 41-50%.

The ovens or drying chambers where the wood drying takes place are provided with ventilation elements for allowing the recirculation of the air, heating elements, moisturizing elements, probes for controlling and recording the environmental conditions, probes for temperature and humidity control inside the oven, a water steam and condensation extraction system, electronic equipment for the management and control of the oven, etc.

Next, the first stage will begin, by introducing the mentioned ash wood into the oven at a temperature of 45° C. and a relative humidity of approximately 60%, for dos weeks, until the wood reaches final values of equilibrium moisture content in a range of 25-40%.

It is worth noting that these values are by way of example and that it will be necessary to adapt these values to the range stated in claim 1, for example by varying the temperature, the relative humidity, the period of time inside the oven, all of which will depend on the characteristics of the wood, since there are no two woods identical to each other. Another possibility would be, if at the end of the two-week period a pre-defined equilibrium moisture content has not been reached, the wood could be kept for an additional period or, if the wood should have reached such humidity content before the set period, the wood should be taken out of the oven in advance.

The second stage consists of arranging the dried ash wood from the first stage in the oven at a temperature of 50° C., a relative humidity of 45% for one week until reaching an equilibrium moisture content between 16% and 25%.

At the third stage, the ash wood obtained from the second stage is placed inside the oven at a temperature of 55° C. and a relative humidity of 35%, for one week, until the wood reaches an equilibrium moisture content in the range of 10-16%.

Next, the dried ash wood obtained from the third stage is allowed to rest at a stable temperature in the range of 18 and 25° C., for at least two weeks, but preferably three weeks, so that the wood recovers part of the lost equilibrium moisture content (in this case, between 1% and 3%, but with other woods it may reach 9%) and such equilibrium moisture content stabilizes. This stage is aimed at de-stressing the wood and thus respecting its morphology.

In the fifth stage the dried wood obtained from the fourth stage is introduced in the oven at a temperature of 55° C. and a relative humidity of 30%, for one week, until the wood reaches an equilibrium moisture content between 10-16%.

In the sixth stage, the dried ash wood from the previous stage is placed inside the oven at a temperature of 45° C., and a relative humidity of 25%, until the wood reaches an equilibrium moisture content between 6-8%.

In the last, seventh stage, the dried wood obtained from the sixth stage is allowed to rest in an indoor warehouse at a controlled temperature between 18 and 25° C. for a minimum of three weeks, preferably four weeks. In this way, the wood recovers 2% of equilibrium moisture content, and smoothly dissipates temperature remains. The dried and stabilized ash wood will thus have reached a final equilibrium moisture content in the range of 8-10%.

As it was explained above, during the first, second, third, fifth and sixth stages, it is possible to intervene on the wood that is being dried if the extrapolations of the parameters do not adjust to the final result, and a water shower may be applied thereon to increase the wood equilibrium humidity or to increase or lower the temperature in order to influence the drying speed, increase or decrease the ventilation to influence the drying, etc.

From the wood obtained in the above-described procedure a number of products can be produced, since the wood increases its flexibility and elasticity 1.5 or 2 times the flexibility and elasticity of wood that has been dried by means of a traditional air-drying procedure.

One of the products made of dried wood is a covering element as illustrated in FIGS. 1 to 5.

A covering element 11 covers the orifice of a container 4. If the covering element is introduced inside the container through the opening, it is called a cap, if it is not introduced, it is called a lid or top, although both these terms may be considered equivalent in Spanish.

Traditionally, these covering elements 11 for use in packaging, for instance, of perfumes, cosmetics, etc., include the use of a plastic insert, e.g., a polypropylene, which provides the mechanical functionality, either by friction, clicking, etc.

Such plastic insert is covered by a wood sleeve, conferring a natural touch to the perfume or cosmetic, whereas inside there is plastic material that is necessary to have the above-stated mechanic functions that wood cannot provide.

The plastic insert and the wooden sleeve are attached to each other by adhesives based on high temperature resin, for example.

Therefore, the idea of this embodiment of the wood obtained according to the above-stated procedure is to create a totally biodegradable product for a sector that demands the use of natural products, with the further advantage that the components will not need to be subsequently separated for recycling, as the plastic insert will no longer be included.

The cap 11 of the practical embodiment (this example would be applicable to a lid as well) is made of the wood obtained according to the procedure, for example, ash wood, and consists of a body 1 that is provided outside and is visible.

Inside the body 1 there is a cavity having walls 3, wherein there are provided the straps 5. When the neck 6 of the container 4 is introduced inside the cavity, said neck pushes the straps 5 outwards, which straps, being flexible, bend towards the walls 3, and which straps 5 being elastic, they recover their position by blocking the neck 6, and the covering element remains attached to the container 4.

The attachment can be increased by adding bulges 10 to the straps 5, said bulges are oriented towards the neck 6 and they fit in protrusions 12 made in the neck 6.

To facilitate the guiding and the fitting of the neck, the possibility of arranging positioning elements 8 in the neck has been envisaged.

In order to reduce the size of the covering element, space for the flexing of the strap 5 has been gained out of the walls 3, by making recesses 9 behind the strapping, which allow the bending manoeuvre of the strap 5 towards the walls 3 and the subsequent elastic recovery of the strap 5.

The ability to flex the wood of the covering element or cap 11 over the container 4 allows it to fit to the bottle, the cap 11 is therefore able to exert force on the el neck 6 of the container and can therefore close the container 4 well. That is, a “pulling force” between the 11 and the container 4 is achieved.

This cap 11 eliminates completely the plastic component, that is, the plastic insert between the body 1 and the neck 6, thus becoming a completely natural and eco-friendly cap 11.

The resin-based adhesives that were needed to attach the insert inside the cavity 2, which required high temperatures, are also unnecessary.

All of which is achieved while maintaining the mechanical functionality and the specifications, since the wood is kept flexible and elastic, thus obtaining a correct adjustment of the cap to the container.

In addition, all European, American, or other special, regulations can be complied with in respect to all sizes.

This invention describes a new procedure for drying wood, the dried wood obtained, and a covering element for containers made of the dried wood obtained. The examples provided herein are not limitative of the present invention, which may have different applications and/or adaptations, all of which within the scope of the following claims.

1. A method for drying wood after the wood has been cut at its origin and has lost moisture and has reached an equilibrium moisture content of 41% or more, the method comprising:
a first stage of placing the wood in an oven at a temperature between 40-50° C. and a relative humidity between 40-50%, for a period between 1 and 3 weeks, until the wood reaches an equilibrium moisture content between 25%-40%,
a second stage of placing the wood in the oven at a temperature between 45-55° C. and a relative humidity between 45-55%, for a period between 4 and 15 days, until the wood reaches an equilibrium moisture content between 16%-25%,
a third stage of placing the wood in the oven at a temperature between 50-60° C. and a relative humidity between 30-40%, for a period between 4 and 15 days, until the wood reaches an equilibrium moisture content between 10%-16%,
a fourth stage of allowing the wood to rest at a controlled temperature between 18-25° C., between 2 and 4 weeks, wherein the wood recovers part of the equilibrium moisture lost in the third stage and stabilizes,
a fifth stage of placing the wood in the oven at a temperature between 50-60° C. and a relative humidity between 25-35%, for a period between 4 and 15 days until the wood reaches an equilibrium moisture content between 10%-16%,
a sixth stage of placing the wood in the oven at a temperature between 40-50° C. and a relative humidity between 20-30%, for a period between 4 and 15 days, until the wood reaches an equilibrium moisture content between 6%-8%, and,
a seventh stage of allowing the wood to rest at a controlled temperature between 18-25° C., for a period between 3 and 5 weeks, whereat the wood recovers between 1.5 and 2.5% equilibrium humidity, the remains of temperature dissipate and the wood stabilizes having a final humidity equilibrium between 8%-10%.

2. The method according to claim 1, further comprising; in at least one stage of the first, second, third, fifth and sixth stages, when the equilibrium moisture content is lower than the preestablished parameters, applying a water shower until the equilibrium moisture content regains the preestablished parameters.

3. The method according to claim 1, further comprising: in at least one stage of the first, second, third, fifth and sixth stages, when the preestablished level of temperature inside the oven does not match the preestablished parameters, varying the temperature inside the oven either cooling down or heating up the oven until reaching again the preestablished values.

4. Dried wood having an equilibrium moisture content of 8-10% and being obtained by the following process:
a first stage of placing the wood in an oven at a temperature between 40-50° C. and a relative humidity between 40-50%, for a period between 1 and 3 weeks, until the wood reaches an equilibrium moisture content between 25%-40%,
a second stage of placing the wood in the oven at a temperature between 45-55° C. and a relative humidity between 45-55%, for a period between 4 and 15 days, until the wood reaches an equilibrium moisture content between 16%-25%,
a third stage of placing the wood in the oven at a temperature between 50-60° C. and a relative humidity between 30-40%, for a period between 4 and 15 days, until the wood reaches an equilibrium moisture content between 10%-16%,
a fourth stage of allowing the wood to rest at a controlled temperature between 18-25° C., between 2 and 4 weeks, wherein the wood recovers part of the equilibrium moisture lost in the third stage and stabilizes,
a fifth stage of placing the wood in the oven at a temperature between 50-60° C. and a relative humidity between 25-35%, for a period between 4 and 15 days until the wood reaches an equilibrium moisture content between 10%-16%,
a sixth stage of placing the wood in the oven at a temperature between 40-50° C. and a relative humidity between 20-30%, for a period between 4 and 15 days, until the wood reaches an equilibrium moisture content between 6%-8%, and,
a seventh stage of allowing the wood to rest at a controlled temperature between 18-25° C., for a period between 3 and 5 weeks, whereat the wood recovers between 1.5 and 2.5% equilibrium humidity, the remains of temperature dissipate and the wood stabilizes having a final humidity equilibrium between 8%-10%.

5. A covering element for containers, the covering element being made of the dried wood comprising an equilibrium moisture content of 8-10% and being attached to an opening or a neck of a container, the covering element including a body (1) that defines a cavity (2) having walls (3) inside which the opening (7) and the neck (6) of the container (4) are provided, and attachment means (5) of the walls (3) to the opening or the neck, the attachment means (5) consisting of at least one strap, the covering element being made by the following process:
a first stage of placing the wood in an oven at a temperature between 40-50° C. and a relative humidity between 40-50%, for a period between 1 and 3 weeks, until the wood reaches an equilibrium moisture content between 25%-40%,
a second stage of placing the wood in the oven at a temperature between 45-55° C. and a relative humidity between 45-55%, for a period between 4 and 15 days, until the wood reaches an equilibrium moisture content between 16%-25%,
a third stage of placing the wood in the oven at a temperature between 50-60° C. and a relative humidity between 30-40%, for a period between 4 and 15 days, until the wood reaches an equilibrium moisture content between 10%-16%,
a fourth stage of allowing the wood to rest at a controlled temperature between 18-25° C., between 2 and 4 weeks, wherein the wood recovers part of the equilibrium moisture lost in the third stage and stabilizes,
a fifth stage of placing the wood in the oven at a temperature between 50-60° C. and a relative humidity between 25-35%, for a period between 4 and 15 days until the wood reaches an equilibrium moisture content between 10%-16%,
a sixth stage of placing the wood in the oven at a temperature between 40-50° C. and a relative humidity between 20-30%, for a period between 4 and 15 days, until the wood reaches an equilibrium moisture content between 6%-8%, and,
a seventh stage of allowing the wood to rest at a controlled temperature between 18-25° C., for a period between 3 and 5 weeks, whereat the wood recovers between 1.5 and 2.5% equilibrium humidity, the remains of temperature dissipate and the wood stabilizes having a final humidity equilibrium between 8%-10%.

6. The covering element according to claim 5, wherein the walls (3) comprise a recess (9) formed behind the strap (5).

7. The covering element according to claim 5, wherein the strap (5), which is at least one in number, comprises at least one bulge (10) that fits in the neck (6) of the container.

8. The covering element according to claim 5, wherein the walls (3) comprise positioning elements (8) of the neck (6).

9. The method according to claim 2, further comprising: in at least one stage of the first, second, third, fifth and sixth stages, when the preestablished level of temperature inside the oven does not match the preestablished parameters, varying the temperature inside the oven either cooling down or heating up the oven until reaching again the preestablished values.

10. The covering element according to claim 6, wherein the strap (5), which is at least one in number, comprises at least one bulge (10) that fits in the neck (6) of the container.

11. The covering element according to claim 6, wherein the walls (3) comprise positioning elements (8) of the neck (6).
